(19) United States
(12) Patent Application Publication
(10) Pub. No.: US 2006/0247876 A1
(43) Pub. Date: Nov. 2, 2006

(54) Liquid crystal panel evaluation support method and computer-readable medium for the same

(75) Inventors: Makoto Yamada, Kanagawa (JP); Keiichi Miyazaki, Kanagawa (JP); Yutaro Mitsumori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/349,946

(22) Filed: Feb. 9, 2006

(30) Foreign Application Priority Data
Feb. 23, 2005 (JP) 2005-047377

(51) Int. Cl. G01N 37/00; G09G 3/36

(52) U.S. Cl. 702/81; 345/87

(57) ABSTRACT

A liquid crystal panel evaluation support method for supporting an evaluation of a color reproducing characteristic of a liquid crystal panel for displaying a color image, comprising: calculating, for all pixels of the liquid crystal panel, a color difference indicative of a difference between a color of an optional pixel of the liquid crystal panel obtained when seeing a display surface of the liquid crystal panel in a first direction to be a front and a color of the optional pixel obtained when seeing the display surface in at least one second direction other than the first direction, in a state in which a color image for an evaluation having a plurality of colors mixed is displayed; and generating index data to be an index for evaluating the color reproducing characteristic of the liquid crystal panel every color image for an evaluation when displaying the color image for an evaluation on the liquid crystal panel based on the color difference calculated for all of the pixels.

### 1. FIELD OF THE INVENTION

The present invention relates to a liquid crystal panel evaluation support method of supporting an evaluation of a color reproducing characteristic of a liquid crystal panel for displaying a color image.

### 2. DESCRIPTION OF THE RELATED ART

In recent years, a liquid crystal panel has been enhanced in picture quality and has widely been utilized for a PC monitor or a domestic TV. However, there is a peculiar problem to the liquid crystal panel in that a fluctuation in a luminance or a change in a color is caused depending on a direction of an observation. If such a dependency on the direction of the observation is present, a display color of a display image is varied depending on a direction in which an observer sees the liquid crystal panel.

For example, even if the same color is displayed for the display color when the liquid crystal panel is seen in front, how to see a color is varied when the liquid crystal panel is seen obliquely. In a large-sized display device in recent years in which the size of a screen is increased greatly, moreover, the direction of the observation is varied depending on a position of the liquid crystal panel. Therefore, there is a problem in that how to see a color is varied if the position of the liquid crystal panel is different and a different color is seen even if the same color is displayed in a central part of the screen and a peripheral part of the screen.

Referring to the problem, there has been proposed an example in which a fluctuation in a luminance and a change in a color depending on the direction of the observation are suppressed by the development of a novel liquid crystal display method and the practical use of an optical compensating film (for example, “Liquid Crystal” Vol. 8, No. 2, pp 86 (2004)). In order to develop such an optical compensating film, it is important that a color reproducing characteristic can be evaluated accurately when these films are used. In the related art, there has been executed a method of displaying an image including only a specific color such as white, black, gray, a flesh color or sky blue on a liquid crystal panel and obtaining a color difference between a color acquired by seeing an optional pixel of the liquid crystal panel from a front in this state and a color acquired by seeing the pixel in a direction other than the front and confirming a degree of a fluctuation in a color depending on the direction of the observation based on the color difference, thereby evaluating a color reproducing characteristic.

In the related art, referring to a certain liquid crystal panel, it is possible to only evaluate a color reproducing characteristic for each specific color, that is, the white and black colors have excellent color reproducing characteristics and the gray and flesh colors do not have very excellent color reproducing characteristics. However, the liquid crystal panel generally serves to display an image having a plurality of colors mixed so as to be used. For this reason, actually, it is more important to confirm a fluctuation in the color of a whole image depending on the direction of the observation and to evaluate the color reproducing characteristic of the liquid crystal panel when displaying a specific image having a plurality of colors mixed as compared with the evaluation of the color reproducing characteristic for each specific color. However, such an evaluating method has not been conventionally proposed.

### SUMMARY OF THE INVENTION

The invention has been made in consideration of the circumstances and has an object to freely evaluate a color reproducing characteristic of a liquid crystal panel for an image having a plurality of colors mixed when displaying the image on the liquid crystal panel.

The invention provides a liquid crystal panel evaluation support method for supporting an evaluation of a color reproducing characteristic of a liquid crystal panel for displaying a color image, comprising: a color difference calculating step of calculating, for all pixels of the liquid crystal panel, a color difference indicative of a difference between a color of an optional pixel of the liquid crystal panel which is obtained when seeing a display surface of the liquid crystal panel in a first direction to be a front and a color of the optional pixel which is obtained when seeing the display surface in a second direction to be at least one of directions other than the front, in a state in which a color image for an evaluation having a plurality of colors mixed is displayed on the liquid crystal panel, and an index data generating step of generating index data to be an index for evaluating the color reproducing characteristic of the liquid crystal panel every color image for an evaluation when displaying the color image for an evaluation on the liquid crystal panel based on the color difference calculated for all of the pixels.

According to the method, it is possible to generate the index data from the color difference indicative of a change in the colors displayed on all of the pixels depending on a direction of an observation. Therefore, it is possible to evaluate the color reproducing characteristic of the liquid crystal panel when displaying the color image having a plurality of colors mixed.

The invention provides the liquid crystal panel evaluation support method, wherein the index data generating step comprises: an average color difference calculating step of calculating an average in all of the pixels of the color difference calculated for all of the pixels as an average color difference for each of the second directions; and a display data generating step of generating, as the index data, data for display to display the second direction as a point and to display a color difference contour line connecting points on which the average color difference has the same value.

According to the method, it is possible to decide a fluctuation in a color visually and instantaneously depending on the direction of the observation every color image for an evaluation and to evaluate the color reproducing characteristic of the liquid crystal panel based on the decision.

The invention provides the liquid crystal panel evaluation support method, wherein the index data generating step comprises: an average color difference calculating step of calculating an average in all of the pixels of the color difference calculated for all of the pixels as an average color difference for each of the second directions; and an added value calculating step of calculating, as the index data, a value obtained by weighting the average color differences for the second directions respectively and adding them.

According to the method, it is possible to decide a fluctuation in a color depending on the direction of the observation every color image for an evaluation in a specific numerical value. Based on this decision, it is possible to evaluate the color reproducing characteristic of the liquid crystal panel.

The invention provides the liquid crystal panel evaluation support method, further comprising: a measured color 3-stimulus value acquiring step of monochromatically displaying a primary color for each predetermined gradation on an optional pixel of the liquid crystal panel, to acquire measured color 3-stimulus values to be three stimulus values when displaying the primary color of the optional pixel obtained by measuring a color in each of the first and second directions; and a 3-stimulus value calculating step of calculating, based on the measured color 3-stimulus values, three stimulus values for each pixel when seeing the liquid crystal panel in each of the first and second directions in a state in which the color image for an evaluation is displayed on the liquid crystal panel, wherein the color difference calculating step calculates the color difference by using the three stimulus values thus calculated.

According to the method, the three stimulus values of each pixel obtained when seeing the liquid crystal panel in the first and second directions in the state in which the color image for an evaluation is displayed on the liquid crystal panel can be calculated without actually measuring the color. Therefore, it is not necessary to measure colors for the three stimulus values for each pixel every time the color image for an evaluation is changed to another image. Consequently, it is possible to shorten a time required for evaluating the liquid crystal panel.

The invention provides the liquid crystal panel evaluation support method, wherein a CIE1976L*u*v color space is used as a color space to be utilized for calculating the color difference.

The invention provides the liquid crystal panel evaluation support method, wherein a CIE1976L*a*b color space is used as a color space to be utilized for calculating the color difference.

The invention provides the liquid crystal panel evaluation support method, wherein a color space defined in LHC of CIECAM02 is used as a color space to be utilized for calculating the color difference.

The invention provides the liquid crystal panel evaluation support method, wherein a first white 3-stimulus value to be a 3-stimulus value obtained when seeing a white point on the liquid crystal panel in the first direction, a second white 3-stimulus value to be a 3-stimulus value obtained when seeing the white point on the liquid crystal panel in the second direction or a third white 3-stimulus value to be a 3-stimulus value which is obtained by adding the first white 3-stimulus value and the second white 3-stimulus value at a predetermined rate is used as a 3-stimulus value on a reference white point to be used for calculating the color difference.

The invention provides a computer-readable medium comprising a set of instructions for supporting an evaluation of a color reproducing characteristic of a liquid crystal panel for displaying a color image, said set of instructions comprising: a color difference calculating step of calculating, for all pixels of the liquid crystal panel, a color difference indicative of a difference between (i) a color of an optional pixel of the liquid crystal panel which is obtained when seeing a display surface of the liquid crystal panel in a first direction to be a front and (ii) a color of the optional pixel which is obtained when seeing the display surface in at least one second direction other than the first direction, in a state in which a color image for an evaluation having a plurality of colors mixed is displayed on the liquid crystal panel; and an index data generating step of generating index data to be an index for evaluating the color reproducing characteristic of the liquid crystal panel every color image for an evaluation when displaying the color image for an evaluation on the liquid crystal panel based on the color difference calculated for all of the pixels.

A liquid crystal panel evaluation support program corresponding to the set of instructions may be installed in a computer to execute each of the steps of the liquid crystal panel evaluation support method described above.

### BRIEF DESCRIPTION OF THE DRAWINGS

FIG. 1 is a diagram showing a schematic structure of a liquid crystal panel evaluating system for explaining an embodiment of the invention;

FIGS. 2A and 2B are diagrams for explaining an azimuth and a polar angle;

FIG. 3 is a flowchart showing a processing procedure for a computer executing a liquid crystal panel evaluation support program; and

FIG. 4 is a diagram showing a color difference contour line map.

### DETAILED DESCRIPTION OF THE INVENTION

An embodiment of the invention will be described below with reference to the drawings.

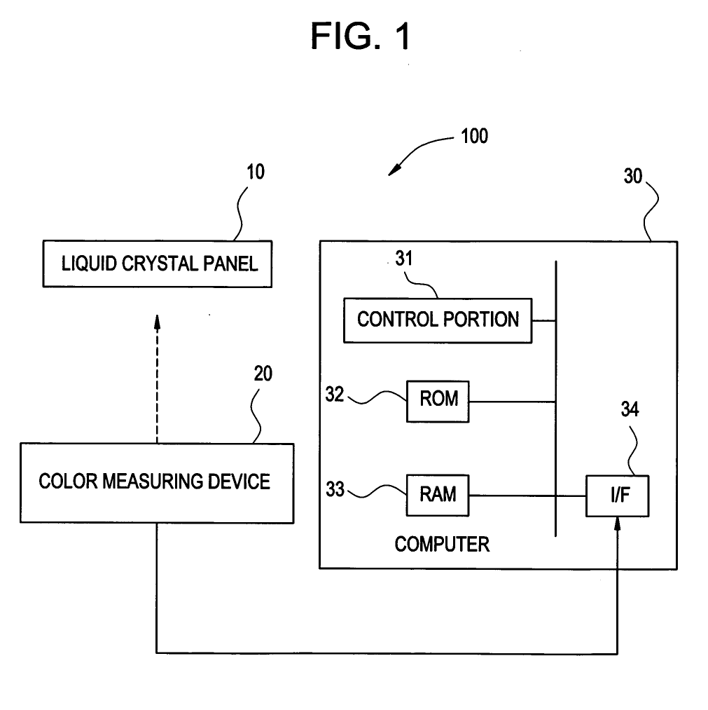

FIG. 1 is a diagram showing a schematic structure of a liquid crystal panel evaluating system for explaining the embodiment according to the invention.

A liquid crystal panel evaluating system 100 shown in FIG. 1 comprises a liquid crystal panel 10 to be an evaluating object, a color measuring device 20 for measuring a color of an image displayed on a display surface of the liquid crystal panel 10, and a computer 30 for executing a liquid crystal panel evaluation support method according to the invention.

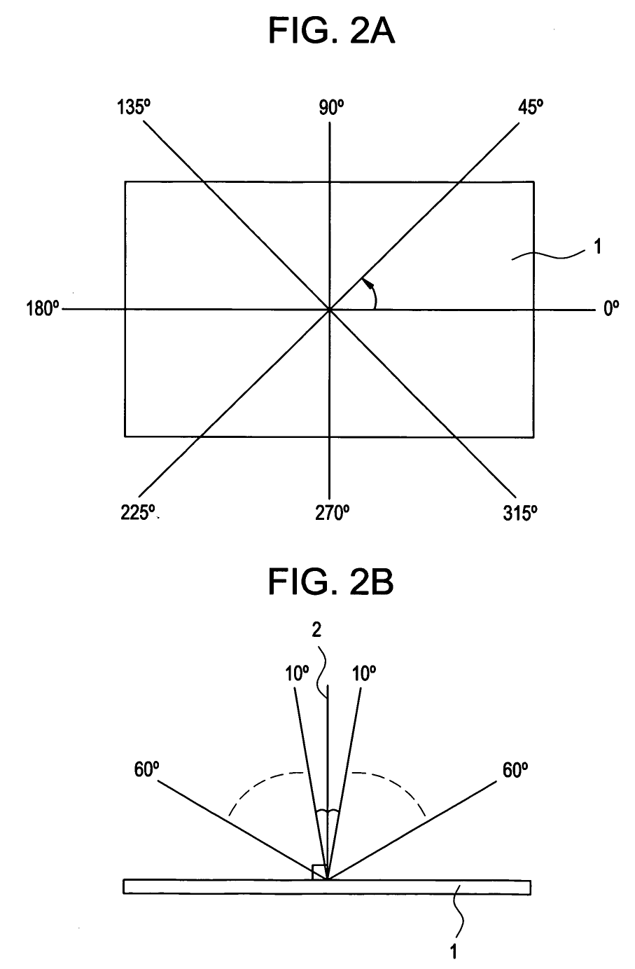

The color measuring device 20 can measure a color in various directions with respect to the display surface of the liquid crystal panel 10. In the embodiment, it is possible to measure a color in 8×7=56 directions in total at eight steps in all at an interval of 45 degrees, that is, an azimuth of 0 degree, 45 degrees, 90 degrees, . . . , 315 degrees on a display surface 1 of the liquid crystal panel 10 as shown in FIG. 2A and at seven steps in all at an interval of 10 degrees, that is, a polar angle formed with respect to the display surface 1 (an angle formed with respect to a perpendicular line 2 to the display surface 1) of 0 degree, 10 degrees, . . . , 60 degrees as shown in FIG. 2B. When the polar angle is 0 degree, a color is measured in the same direction irrespective of the azimuth. Therefore, it is possible to accurately measure a color in 49 directions. In the following, it is assumed that the numeral i is attached to each of the azimuths in the eight steps and takes a value of 1 to 8 in ascending order from the smallest angle. Moreover, it is assumed that the numeral j is attached to each of the polar angles in the seven steps and takes a value of 1 to 7 in ascending order from the smallest angle.

The liquid crystal panel 10 includes two transparent electrodes interposing a liquid crystal layer therebetween and a color filter provided on the transparent electrodes, and serves to display a color image. One pixel of the liquid crystal panel 10 is constituted by three color filters for R (read), G (green) and B (blue) which are close to each other.

The computer 30 includes a control portion 31 constituted mainly by a processor for executing a program including a liquid crystal panel evaluation support program according to the invention, an ROM 32 for storing a program, an RAM 33 to be a work memory, and an input/output interface 34 for transferring data from/to an outside.

Description will be given to a liquid crystal panel evaluation support method to be implemented by the execution of the liquid crystal panel evaluation support program through the computer 30.

In order to execute the liquid crystal panel evaluation support method, the following preparation is carried out.

First of all, an optional pixel a of the liquid crystal panel 10 is brought into such a state that only R is displayed, and a gradation k of R (for example, k=0 to 255) is changed in order and a color of the pixel a is measured for each gradation of R by the color measuring device 20 to obtain 3-stimulus values f_{X,R}(k), f_{Y,R}(k) and f_{Z,R}(k) for X, Y and Z. The gradation k does not need to be changed every gradation but may be changed every 10 gradations to obtain the three stimulus values, for example. Moreover, the 3-stimulus values f_{X,R}(k), f_{Y,R}(k) and f_{Z,R}(k) for X, Y and Z are obtained for all of the 56 directions.

Next, the pixel a of the liquid crystal panel 10 is brought into a state in which only G is displayed, and the gradation k of G (k=0 to 255) is changed in order and a color of the pixel a is measured by the color measuring device 20 every gradation of G to obtain the three stimulus values f_{X,G}(k), f_{Y,G}(k) and f_{Z,G}(k) for X, Y and Z. The gradation k does not need to be changed every gradation but may be changed every ten gradations to obtain the three stimulus values, for example. Moreover, the three stimulus values f_{X,G}(k), f_{Y,G}(k) and f_{Z,G}(k) for X, Y and Z are obtained for all of the 56 directions.

Next, the pixel a of the liquid crystal panel 10 is brought into such a state that only B is displayed, and the gradation k of B (for example, k 0 to 255) is changed in order and a color of the pixel a is measured for each gradation of B by the color measuring device 20 to obtain three stimulus values f_{X,B}(k), f_{Y,B}(k) and f_{Z,B}(k) for X, Y and Z. The gradation k does not need to be changed every gradation but may be changed every 10 gradations to obtain the three stimulus values, for example. Moreover, the three stimulus values f_{X,B}(k), f_{Y,B}(k) and f_{Z,B}(k) for X, Y and Z are obtained for all of the 56 directions.

f_{X,R}(k), f_{Y,R}(k) and f_{Z,R}(k), f_{X,G}(k), f_{Y,G}(k) and f_{Z,G}(k), and f_{X,B}(k), f_{Y,B}(k) and f_{Z,B}(k) are obtained by measuring the color of the pixel, respectively. Therefore, they will be hereinafter referred to as measured color 3-stimulus values collectively.

Consequently, 56 measured color 3-stimulus values represented in a function of the gradation k are obtained for one pixel of the liquid crystal panel 10. The measured color 3-stimulus values are stored in the ROM 32 of the computer 30 through the input/output interface 34 so that the preparation is completed.

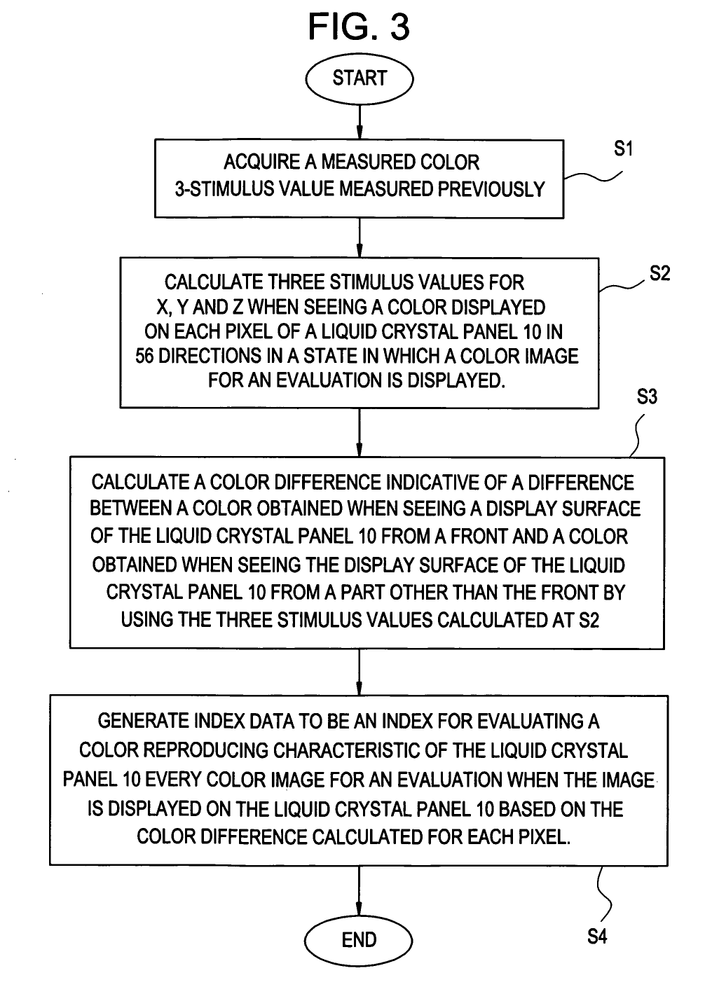

FIG. 3 is a flowchart showing a processing procedure for a computer executing the liquid crystal panel evaluation support program.

First of all, a user starts a liquid crystal panel evaluation support program and inputs, to the computer 30, color image data for an evaluation to evaluate the liquid crystal panel 10. The color image data for an evaluation have a plurality of colors mixed and image data mainly including a color to be evaluated are selected. For example, in the case in which importance is to be attached to the color reproducing characteristics of a flesh color and a gray color, it is preferable to prepare image data including the flesh color and the gray color greatly (N1 of standard image data ISO/JIS-SCID issued by the Japanese Standards Association, for example). In the case in which various colors are to be evaluated uniformly, it is preferable to utilize Macbeth chart image data. In order to execute a simple and easy evaluation, the image data do not need to be always prepared but a set of some color data may be prepared.

When the color image data for an evaluation are input, the control portion 31 acquires the measured color 3-stimulus values from the ROM 32 (S1) and there are calculated three stimulus values for X, Y and Z by seeing a color displayed on each pixel in the 56 directions in a state in which a color image for an evaluation is displayed based on the measured color 3-simulus value and signals to be originals of three colors displayed on each pixel of the liquid crystal panel 10 (a red signal is represented as r, a green signal is represented as g and a blue signal is represented as b) in color signals constituting the color image data for an evaluation (S2).

The three stimulus values for X, Y and Z are obtained by substituting each of the gradations of the color signals r, g and b displayed on a pixel in the following Equation (1).
X=f_{X,R}(k)+f_{X,G}(k)+f_{X,B}(k)
Y=f_{Y,R}(k)+f_{Y,G}(k)+f_{Y,B}(k)
Z=f_{Z,R}(k)+f_{Z,G}(k)+f_{Z,B}(k) (1)

By using the three stimulus values obtained in the Equation (1), next, there is calculated a color difference in a color space indicative of a difference between a color obtained by seeing the display surface 1 from a front to be a first direction (i=1 to 8, j=1) and a color obtained by seeing the display surface 1 from a part other than the front which is a second direction (i=1 to 8, j=2 to 7) in each pixel of the liquid crystal panel 10 in a state in which a color image for an evaluation based on the color image data for an evaluation is displayed on the liquid crystal panel 10 (S3). At the step S3, color differences (of which number is 48 in total) between a color for one pattern seen from the front and a color for each of 48 patterns seen from the part other than the front are calculated. The color differences thus calculated are obtained every second direction. In the following, therefore, the color difference thus obtained will be represented as dij (j is a numeric value excluding 1).

Any of a CIE1976L*u*v color space, a CIE1976L*a*b* color space and a color space defined by LHC of CIECAM02 is used for calculating the color difference. As three stimulus values (Xw, Yw, Zw) on a reference white point required for calculating L*u*v, L*a*b or LHC of CIECAM02, there are used three stimulus values obtained by causing an optional pixel of the liquid crystal panel 10 to display a white color and seeing the optional pixel in the first direction (which can be calculated by setting, as 255, all of values of k of the measured color 3-stimulus value obtained by measuring a color in the first direction and will be hereinafter referred to as a first white 3-stimulus value), any of three stimulus values having 48 patterns obtained by seeing the optional pixel in the second direction (which can be calculated by setting, as 255, all of values of k of the measured color 3-stimulus value obtained by measuring a color in the second direction) (which will be hereinafter referred to as a second white 3-stimulus value), and a third white 3-stimulus value obtained by adding the first white 3-stimulus value and the second white 3-stimulus value at a predetermined rate by the following Equation (2).
Xw=α*Xw1+(1−α)*Xw2
Yw=α*Yw1+(1−α)*Yw2
Zw=α*Zw1+(1−α)*Zw2 (2)

wherein Xw1, Yw1 and Zw1 represent the first white 3-stimulus value and Xw2, Yw2 and Zw2 represent the second white 3-stimulus value. Furthermore, 0≦α≦1 is set.

There are generated index data to be an index for evaluating the color reproducing characteristic of the liquid crystal panel 10 every color image for an evaluation when the image is displayed on, the liquid crystal panel 10 based on the color difference dij obtained for each pixel (S4).

The following two patterns can be proposed for generating the index data.

(First Pattern)

The control portion 31 adds, for all of the pixels, the color difference dij obtained for each pixel and a value obtained by the addition is divided by the total number of the pixels to calculate an average color difference Dij (j is a numeric value excluding 1). For the index data, then, the second direction is displayed as a point on a two-dimensional plane to generate data for display to display a color difference contour line obtained by connecting points on which the average color difference Dij has the same value.

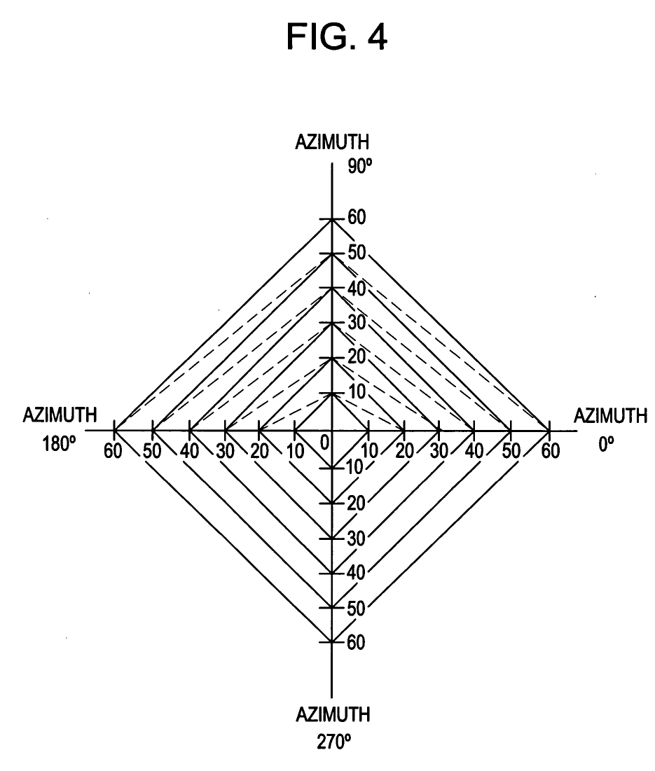

By inputting the data for display to a display device, for example, there is displayed a map in which an azimuth is taken on an XY plane and a polar angle is taken for scales of X and Y axes, and a color difference contour line connecting points in the direction of the observation in which the average color difference Dij have the same value is displayed on a map as shown in FIG. 4. By seeing the map, it is possible to see a change in a color difference contour line every color image for an evaluation, thereby making a decision instantaneously. For example, it is possible to decide that a color is varied when seeing, in directions of azimuths 0 to 180 degrees and 180 to 360 degrees, a color image for an evaluation on which a color difference contour line shown in a dotted line in FIG. 4 is displayed. Thus, it is possible to evaluate a color reproducing characteristic every color image for an evaluation when causing the liquid crystal panel 10 to display a color image for an evaluation by the color difference contour line displayed based on the data for display.

(Second Pattern)

The control portion 31 adds, for all of pixels, the color difference dij obtained for each pixel and divides a value obtained by the addition by the total number of pixels, thereby calculating the average color difference Dij (j is a numeric value excluding 1). Then, a sum S of values obtained by multiplying the average color difference Dij by a weighting constant Wij (j is a numeric value excluding 1) is calculated by Equation (3) and is set to be the index data. The weighting for the average color difference Dij is set in such a manner that a specific gravity is increased depending on the direction of the observation which is felt to be particularly important by a user utilizing the liquid crystal panel 10. For example, it is preferable that the weighting constant Wij should be set to be proportional to a display area of the liquid crystal panel 10 seen in the direction of the observation.

$$S = {\sum }_{i} {\sum }_{j} Wij * Dij \qquad ( 3 )$$

By a numeric value S calculated in the Equation (3), it is possible to quantitatively know an amount of a fluctuation in a general color of a whole image depending on the direction of the observation when the color image for an evaluation is displayed on the liquid crystal panel 10.

Therefore, it is possible to evaluate the color reproducing characteristic of the liquid crystal panel 10 every color image for an evaluation when the color image for an evaluation is displayed on the liquid crystal panel 10.

As described above, according to the liquid crystal panel evaluation support method in accordance with the embodiment, it is possible to carry out an evaluation for a color image having a plurality of colors mixed although the liquid crystal panel can be only evaluated for each specific color in the related art. Therefore, it is possible to carry out an evaluation more practically.

While three stimulus values for each pixel obtained by seeing the liquid crystal panel 10 in the first and second directions respectively in a state in which the color image for an evaluation is displayed on the liquid crystal panel 10 are calculated by using a measured color 3-stimulus value acquired previously without actually measuring the color in the embodiment, the three stimulus values for each pixel may be obtained by actually measuring a color. In this case, it is not necessary to previously obtain the measured color 3-stimulus value.

Moreover, it is also possible to obtain the first white 3-stimulus value and the second white 3-stimulus value which are to be used for calculating the color difference by actually displaying a white color on an optical pixel of the liquid crystal panel 10 to measure a color of the pixel in the first and second directions by the color measuring device 2 respectively without using the measured color 3-stimulus value.

While a plurality of second directions is set in the embodiment, furthermore, it is possible to obtain an advantage even if one second direction is set.

According to the invention, it is possible to evaluate the color reproducing characteristic of a liquid crystal panel for an image having a plurality of colors mixed when displaying the image on the liquid crystal panel.

The entire disclosure of each and every foreign patent application from which the benefit of foreign priority has been claimed in the present application is incorporated herein by reference, as if fully set forth.

What is claimed is:

1. A liquid crystal panel evaluation support method for supporting an evaluation of a color reproducing characteristic of a liquid crystal panel for displaying a color image, comprising:
a color difference calculating step of calculating, for all pixels of the liquid crystal panel, a color difference indicative of a difference between (i) a color of an optional pixel of the liquid crystal panel which is obtained when seeing a display surface of the liquid crystal panel in a first direction to be a front and (ii) a color of the optional pixel which is obtained when seeing the display surface in at least one second direction other than the first direction, in a state in which a color image for an evaluation having a plurality of colors mixed is displayed on the liquid crystal panel; and
an index data generating step of generating index data to be an index for evaluating the color reproducing characteristic of the liquid crystal panel every color image for an evaluation when displaying the color image for an evaluation on the liquid crystal panel based on the color difference calculated for all of the pixels.

2. The liquid crystal panel evaluation support method according to claim 1,
wherein the index data generating step comprises:
an average color difference calculating step of calculating an average in all of the pixels of the color difference calculated for all of the pixels as an average color difference for each of said at least one second direction; and
a display data generating step of generating, as the index data, data for display to display each of said at least one second direction as a point and to display a color difference contour line connecting points on which the average color difference has the same value.

3. The liquid crystal panel evaluation support method according to claim 1,
wherein the index data generating step includes:
an average color difference calculating step of calculating an average in all of the pixels of the color difference calculated for all of the pixels as an average color difference for each of said at least one second direction; and
an added value calculating step of calculating, as the index data, a value obtained by weighting the average color difference for each of said at least one second direction, and adding the weighted average color differences.

4. The liquid crystal panel evaluation support method according to claim 1, further comprising:
a measured color 3-stimulus value acquiring step of monochromatically displaying a primary color for each predetermined gradation on an optional pixel of the liquid crystal panel, to acquire measured color 3-stimulus values to be three stimulus values when displaying the primary color of the optional pixel obtained by measuring a color in each of the first direction and said at least one second direction; and
a 3-stimulus value calculating step of calculating, based on the measured color 3-stimulus values, three stimulus values for each pixel when seeing the liquid crystal panel in each of the first and said at least one second direction in a state in which the color image for an evaluation is displayed on the liquid crystal panel,
wherein the color difference calculating step calculates the color difference by using the three stimulus values thus calculated.

5. The liquid crystal panel evaluation support method according to claim 1,
wherein a CIE1976L*u*v color space is used as a color space to be utilized for calculating the color difference.

6. The liquid crystal panel evaluation support method according to claims 1,
wherein a CIE1976L*a*b color space is used as a color space to be utilized for calculating the color difference.

7. The liquid crystal panel evaluation support method according to claim 1,
wherein a color space defined in LHC of CIECAM02 is used as a color space to be utilized for calculating the color difference.

8. The liquid crystal panel evaluation support method according to claim 5,
wherein one of: a first white 3-stimulus value to be a 3-stimulus value obtained when seeing a white point on the liquid crystal panel in the first direction; a second white 3-stimulus value to be a 3-stimulus value obtained when seeing the white point on the liquid crystal panel in the second direction; and a third white 3-stimulus value to be a 3-stimulus value which is obtained by adding the first white 3-stimulus value and the second white 3-stimulus value at a predetermined rate is used as a 3-stimulus value on a reference white point to be used for calculating the color difference.

9. The liquid crystal panel evaluation support method according to claim 6,
wherein one of: a first white 3-stimulus value to be a 3-stimulus value obtained when seeing a white point on the liquid crystal panel in the first direction; a second white 3-stimulus value to be a 3-stimulus value obtained when seeing the white point on the liquid crystal panel in the second direction; and a third white 3-stimulus value to be a 3-stimulus value which is obtained by adding the first white 3-stimulus value and the second white 3-stimulus value at a predetermined rate is used as a 3-stimulus value on a reference white point to be used for calculating the color difference.

10. The liquid crystal panel evaluation support method according to claim 7,
wherein one of: a first white 3-stimulus value to be a 3-stimulus value obtained when seeing a white point on the liquid crystal panel in the first direction; a second white 3-stimulus value to be a 3-stimulus value obtained when seeing the white point on the liquid crystal panel in the second direction; and a third white 3-stimulus value to be a 3-stimulus value which is obtained by adding the first white 3-stimulus value and the second white 3-stimulus value at a predetermined rate is used as a 3-stimulus value on a reference white point to be used for calculating the color difference.

11. A computer-readable medium comprising a set of instructions for supporting an evaluation of a color reproducing characteristic of a liquid crystal panel for displaying a color image, said set of instructions comprising:
a color difference calculating step of calculating, for all pixels of the liquid crystal panel, a color difference indicative of a difference between (i) a color of an optional pixel of the liquid crystal panel which is obtained when seeing a display surface of the liquid crystal panel in a first direction to be a front and (ii) a color of the optional pixel which is obtained when seeing the display surface in at least one second direction other than the first direction, in a state in which a color image for an evaluation having a plurality of colors mixed is displayed on the liquid crystal panel; and
an index data generating step of generating index data to be an index for evaluating the color reproducing characteristic of the liquid crystal panel every color image for an evaluation when displaying the color image for an evaluation on the liquid crystal panel based on the color difference calculated for all of the pixels.
